(19) United States
(12) Patent Application Publication
(10) Pub. No.: US 2025/0074499 A1
(43) Pub. Date: Mar. 6, 2025

(54) ROTARY POSITIONING DEVICE AND ITS APPLICATION METHOD

(71) Applicant: HANWIT PRECISION INDUSTRIES LTD., New Taipei (TW)

(72) Inventors: Ying-Chih TSENG, New Taipei (TW); Ming-De WU, New Taipei (TW)

(21) Appl. No.: 18/949,587

(22) Filed: Nov. 15, 2024

Related U.S. Application Data
(63) Continuation-in-part of application No. 18/106,636, filed on Feb. 7, 2023.
Application No. 18/106,636 is a continuation-in-part of application No. 17/510,777, filed on Oct. 26, 2021.
(63) Continuation-in-part of application No. 17/713,429, filed on Apr. 5, 2022.
Application No. 17/713,429 is a continuation-in-part of application No. 17/510,777, filed on Oct. 26, 2021.
(63) Continuation-in-part of application No. 17/722,813, filed on Apr. 18, 2022.
Application No. 17/722,813 is a continuation-in-part of application No. 17/510,777, filed on Oct. 26, 2021.
(63) Continuation-in-part of application No. 17/510,777, filed on Oct. 26, 2021.

(30) Foreign Application Priority Data
Oct. 8, 2021 (TW) 110137594
Oct. 8, 2021 (TW) 110137595

(51) Int. Cl. B62D 5/00

(52) U.S. Cl. CPC B62D 5/005

(57) ABSTRACT

An application method of a rotary positioning device, which has a limit member, a rotary block and an elastic member mounted in a housing assembled at a preset panel with the steering shaft portion of the rotary block exposed outside the cover, and has the stopper of a docking shaft assembled at another preset panel inserted into the housing and the limit member to pass through two limiting balls and rest on the top of an accommodation chamber. Pulling up the steering shaft portion causes the elastic member to drive rotary slideways of the rotary block and rotation guides of the limit member to slide axially, so as to drive the accommodation chamber of the rotary block to rotate, push the two limiting balls into the slots of the limit member, and abut against the stopper, thus completing the assembly and positioning of the two preset panels.

### CROSS REFERENCE TO THE RELATED APPLICATIONS

This application is a Continuation-In-Part of application Ser. No. 18/106,636, filed on Feb. 7, 2023; which is a Continuation-In-Part of application Ser. No. 17/510,777, filed on Oct. 26, 2021; this application is a Continuation-In-Part of application Ser. No. 17/713,429, filed on Apr. 5, 2022; which is a Continuation-In-Part of application Ser. No. 17/510,777, filed on Oct. 26, 2021; this application is a Continuation-In-Part of application Ser. No. 17/722,813, filed on Apr. 18, 2022; which is a Continuation-In-Part of application Ser. No. 17/510,777, filed on Oct. 26, 2021; this application is also a Continuation-In-Part of application Ser. No. 17/510,777, filed on Oct. 26, 2021; for which priority is claimed under 35 U.S.C. § 120, the entire contents of all of which are hereby incorporated by reference.

This application claims the priority benefit of Taiwan patent application number 110137595, filed on Oct. 8, 2021 and Taiwan patent application number 110137594, filed on Oct. 8, 2021.

### BACKGROUND OF THE INVENTION

### 1. Field of the Invention

The invention provides a rotary positioning device and its application method, especially refers to the application method of a positioning device which can be easily operated for automatic docking locking and manual rotation unlocking, wherein the limit member assembled inside the housing is provided with a rotary block, so that the two rotation guides of the limit member and the two rotary slideways of the rotary block can rotate and slide relative to each other, and rise and fall to be relatively connected or separated from the docking shaft, so as to achieve the purpose of conveniently operating the positioning device by pressing and rotating to perform locking or unlocking.

### 2. Description of the Related Art

In daily life, many objects are moved back and forth, and positioning mechanisms such as screws or latches are used to achieve the positioning effect. For example, for items with telescopic structures such as drawers and case panels, after the rails and chutes are moved to a predetermined position, screws or latches are used to temporarily position the rails and chutes, so that users can work while the rails and chutes are positioned and not moving. Or in equipment such as desktop computers, laptops, industrial computers, workstations, etc. that are assembled using multiple devices or mechanisms, screws or pins are used to position the panels in a stacked state, so that the outer shell of the multiple devices or mechanisms is provided with a panel that can be assembled and disassembled movably, or the multiple devices or mechanisms can be assembled or disassembled relatively conveniently.

Furthermore, in addition to the tips and threads of ordinary screws and pins, which can cause injuries to users if they accidentally touch them, the entire screws or pins must be removed when disassembling devices, mechanisms or panels, which often leads to the problem of screw or pin loss. If the user does not have spare screws or pins, and uses the remaining screws or pins for assembly, the assembled mechanism or panels will be unstable and easily loose or detached. Also, after removing many screws or pins, they will be placed in the same position, and it will be difficult to find the corresponding screws or pins for assembly and fixing. Furthermore, when disassembling or assembling screws or pins, most of them require the use of hand tools (such as screwdrivers or wrenches, etc.). As the types of screws or pins are different, users need to prepare many hand tools, which often leads to unsmooth assembly and disassembly operations. As the above problems and defects continue to occur in actual use, it is extremely inconvenient to use screws or pins to stack and position the panels.

In addition, a lever-type fastener is usually provided at the slots of various interface cards or expansion cards of the electronic device to fix the various interface cards or expansion cards, so that the electronic device can be expanded with various functions. However, due to various slots for interface cards or expansion cards currently available, when inserting or removing the interface card or expansion card, the lever-type fastener must be first opened to lock or unlock the fastener. However, due to the space limitation of the slots where the interface cards or expansion cards are installed, it is very inconvenient to open the fasteners. If the interface cards or expansion cards are not inserted securely, the interface cards or expansion cards may not be used or may not be operated properly. It may also cause the various interface cards or expansion cards to be damaged due to collision or friction with surrounding objects when being inserted or removed. There are still many defects in actual application.

Therefore, how to solve the inconvenience and troubles of the conventional positioning device in application and operation, as well as the troubles and defects of assembly and positioning that are not conducive to plugging or unplugging, is the direction that the relevant manufacturers in this industry are eager to study and improve.

### SUMMARY OF THE INVENTION

Therefore, in view of the above-mentioned problems and deficiencies, the inventor collected relevant information, and after many evaluations and considerations, he designed the invention of this rotary positioning device and its application method.

The main object of the present invention is that the rotary positioning device has a perforation at the bottom of the receiving space of the base of the housing, and the inner assembly space of the cover assembled on the base is convexly provided with a sleeve portion having a through hole extending to the receiving space, and the limit member assembled in the receiving space is provided with limiting balls in the slots on both sides of the through axial hole, and two opposite rotation guides are provided on the outside, and the limit member is equipped with a rotary block outside, so that the two relative rotary slideways at the bottom of the accommodation chamber inside the rotary block can slide along the rotation guides outside the limit member to slide, move, and rise and fall relative to each other, and positioning means is provided at adjacent positions of the two rotation guides and the two rotary slideways, so that the steering shaft portion of the rotary block can be movably inserted into the through hole of the cover, and the elastic member is set between the sleeve portion and the rotary block, and the docking shaft is movably inserted through the perforation of the base and the through axial hole of the limit member, so that the stopper at the top the docking shaft can push the limiting balls on both sides of the through axial hole to move in each slot, so as to achieve the purpose of conveniently operating the positioning device to lock or unlock. Thus, the rotary positioning device can be locked by vertical automatic rotation docking or unlocked by manual rotation, and is not easily obstructed by surrounding space or objects, making it easy to operate and assemble.

Another object of the present invention is that a coupling portion is provided on the outside of the perforation of the base of the housing for connection with a preset panel, a connecting portion is provided on the outside of the receiving space relative to the perforation and the coupling portion, the wall of the assembly space of the cover is provided with an engaging portion, which can be connected with the connecting portion for assembly, the base of the housing is provided with at least one inverted hook-shaped connecting portion outside the receiving space, and the wall surface of the assembly space of the cover is provided with at least one engaging portion in a hook shape, which can be connected with the at least one inverted hook-shaped connecting portion and assembled by buckling.

Still another object of the present invention is that a fixing structure is provided for fixing the base of the housing at the bottom of the receiving space and the bottom surface of the limit member, and the fixing structure is provided with at least one fixing groove at the bottom of the receiving space and at the bottom of the limit member, and at least one protruding block can be fixed with the at least one fixing groove, so that the at least one fixing groove and the at least one protruding block can be assembled and combined in a relative locking manner.

Still another object of the present invention is that the rotary block is provided with an elliptical accommodation chamber inside, and the minor axis diameter of the elliptical accommodation chamber may be slightly larger than the rod diameter of the limit member, and the major axis diameter of the accommodation chamber is larger than the rod diameter of the limit member, so that the elliptical accommodation chamber of the rotary block can be located outside the limit member and axially rotate; therefore, when the minor axis diameter of the accommodation chamber is aligned with the two limiting balls of the limit member, the two limiting balls can be pushed into the two slots and locked on the stopper of the docking shaft, or when the major axis diameter of the accommodation chamber is aligned with the two limiting balls of the limit member, the two limiting balls can be moved to partially expose outside the two slots and abut against the major axis diameter of the accommodation chamber, and the stopper of the docking shaft can pass over the two limiting balls and be separated from the housing and the limit member.

Still another object of the present invention is that a first limiting hole is provided on the outer top surface of the sleeve portion inside the assembly space of the cover for the first latching rod provided on one side of the elastic member to be inserted and fixed, and a second limiting hole is provided on the outer side of the steering shaft portion at the rotary block for the second latching rod provided on the other side of the elastic member to be inserted and fixed, and the rotary block is located in the assembly space of the cover and can be rotated to drive the elastic member to twist and form elastic torque, so that the cover, the rotary block and the twisted elastic member can be assembled and combined in the receiving space of the base so that the elastic member can be stably mounted between the outside of the sleeve portion and the rotary block.

Still another object of the present invention is that the rotary block is provided with positioning means at the positions adjacent to the rotary slideways at the bottom of the accommodation chamber and the two rotation guides outside the limit member for movable assembly and separation, and the positioning means provides relatively embedded retaining protrusions and locking grooves, or locking rods and locking holes at two adjacent joints of each rotation guide and each rotary slideway, which can be movably locked or separated, so that each rotation guide and each rotary slideway can be relatively rotated, slidable or locked for positioning.

Still another object of the present invention is that the docking shaft comprises a stopper, a shaft extending from one side of the stopper, a shaft seat connected to one side of the shaft, a base body connected to one side of the shaft seat, and a docking portion connected to one side of the base body, that is, the shaft with reduced rod diameter is connected to one side of the stopper of the docking shaft, the shaft seat with enlarged rod diameter is connected to one side of the shaft, the base body with enlarged outer diameter is connected to one side of the shaft seat, the docking portion with reduced rod diameter and multiple locking ribs is connected to one side of the base body, and the stopper of the docking shaft is provided with a first guide slope that extends obliquely to the shaft, and a second guide slope that is inclined outwardly and is provided on the other side of the stopper relative to the first guide slope, and the docking portion of the docking shaft is for assembly at another preset panel.

### BRIEF DESCRIPTION OF THE DRAWINGS

FIG. 1 is a flow chart (I) of the present invention.

FIG. 2 is a flow chart (II) of the present invention.

FIG. 3 is a three-dimensional external view of the present invention.

FIG. 4 is a three-dimensional external view of the present invention from another viewing angle.

FIG. 5 is a three-dimensional exploded view of the present invention.

FIG. 6 is a three-dimensional exploded view of the present invention from another viewing angle.

FIG. 7 is a side cross-sectional view of the present invention before assembly.

FIG. 8 is a side cross-sectional view of the present invention from another direction before assembly.

FIG. 9 is a side cross-sectional view of the present invention during assembly.

FIG. 10 is a side cross-sectional view of the present invention after assembly.

FIG. 11 is a side cross-sectional view of the present invention when locked.

FIG. 12 is a top cross-sectional view of the present invention when locked.

FIG. 13 is a side cross-sectional view of the present invention when unlocked.

FIG. 14 is a top view of the invention when unlocked.

### DETAILED DESCRIPTION OF THE INVENTION

In order to achieve the above objects and effects, the technical means and structures adopted by the present invention are described in detail below with respect to the preferred embodiment of the present invention, so as to facilitate a complete understanding.

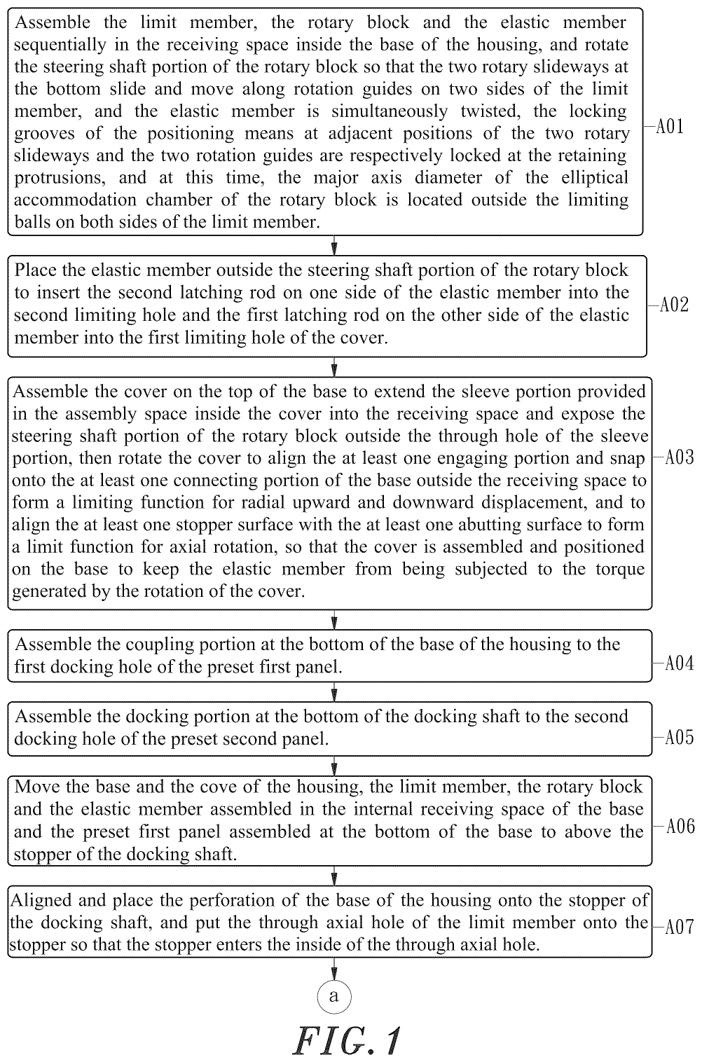

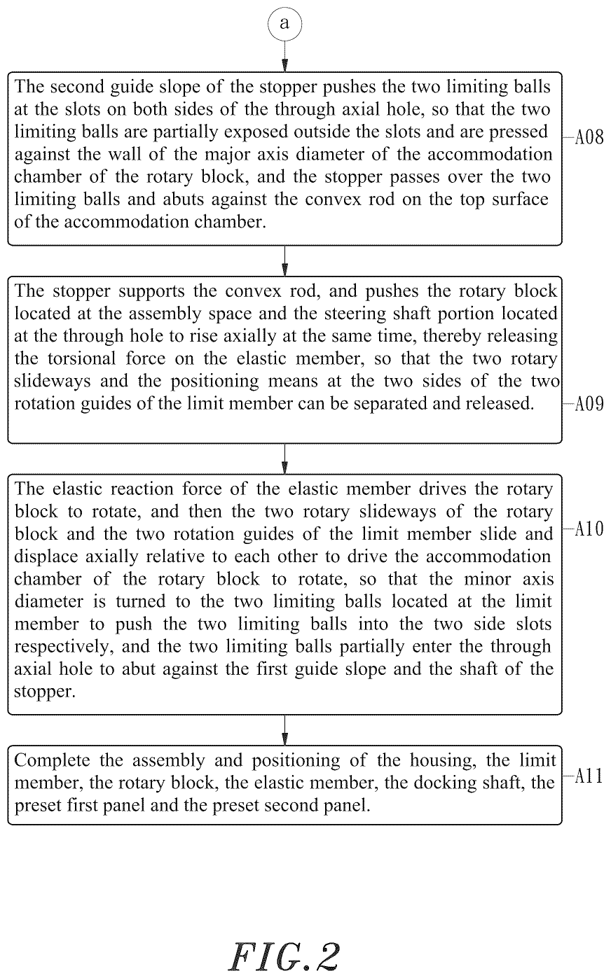

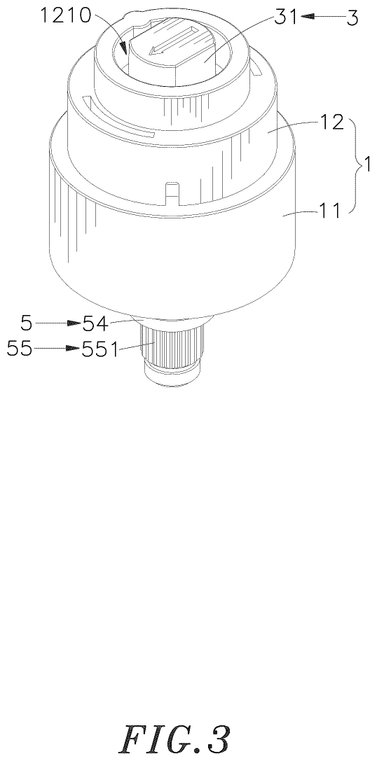

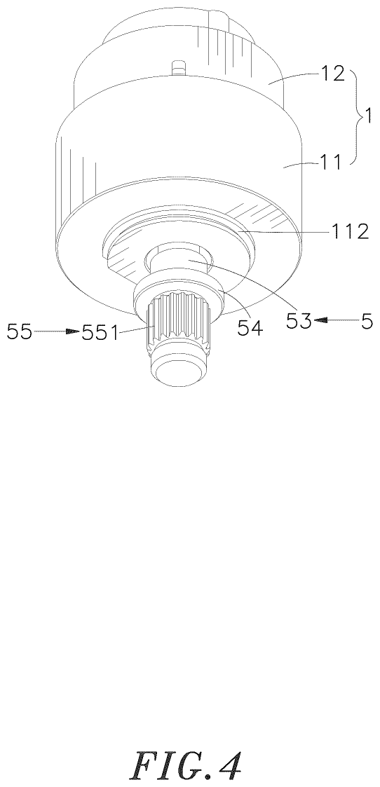

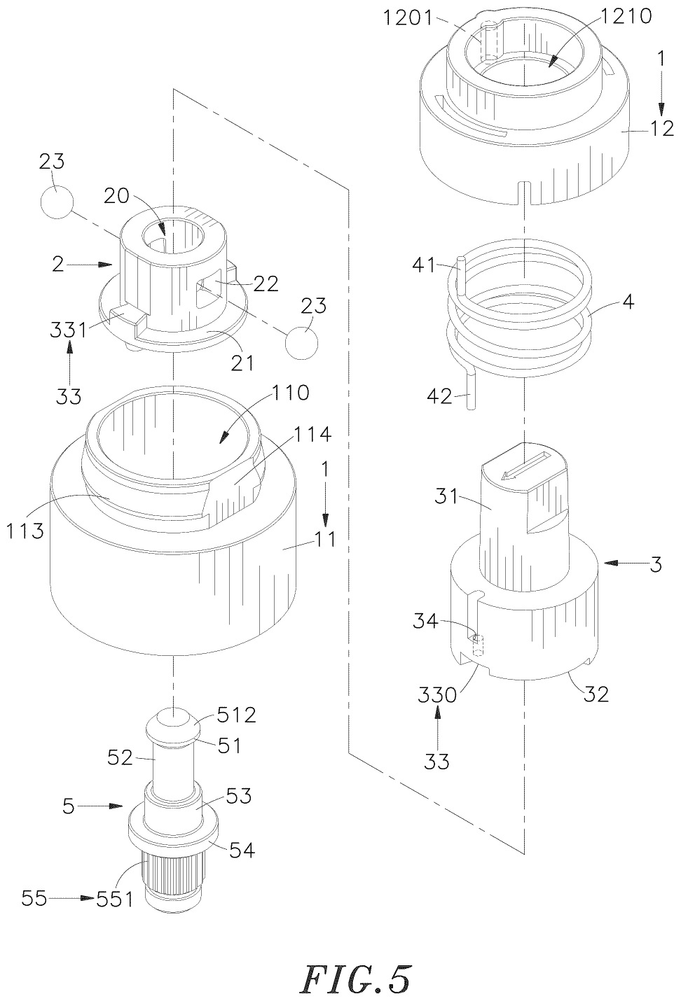

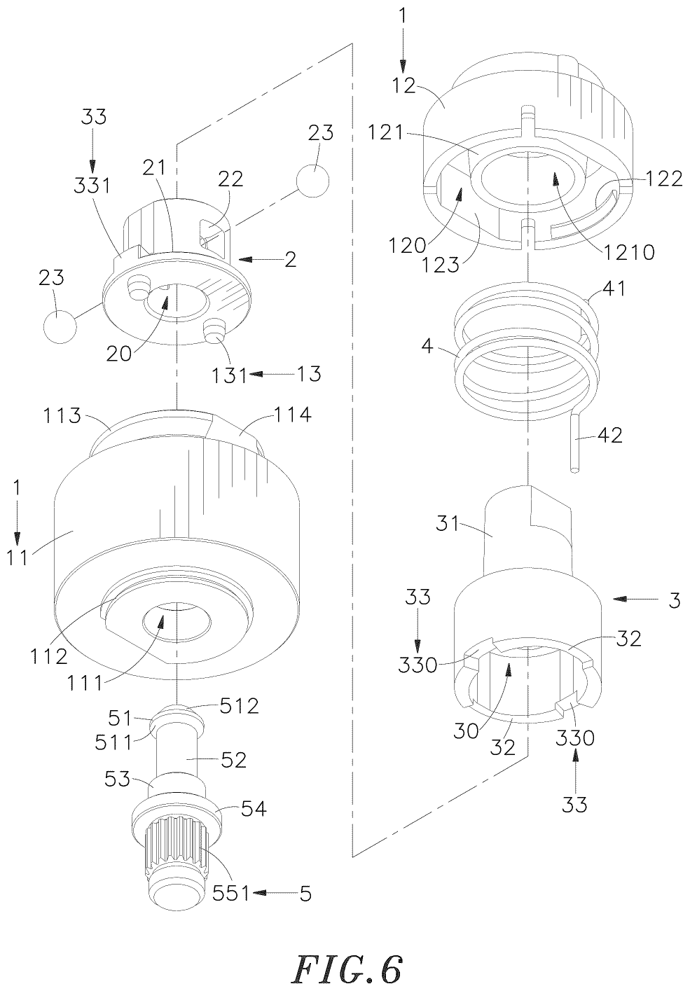

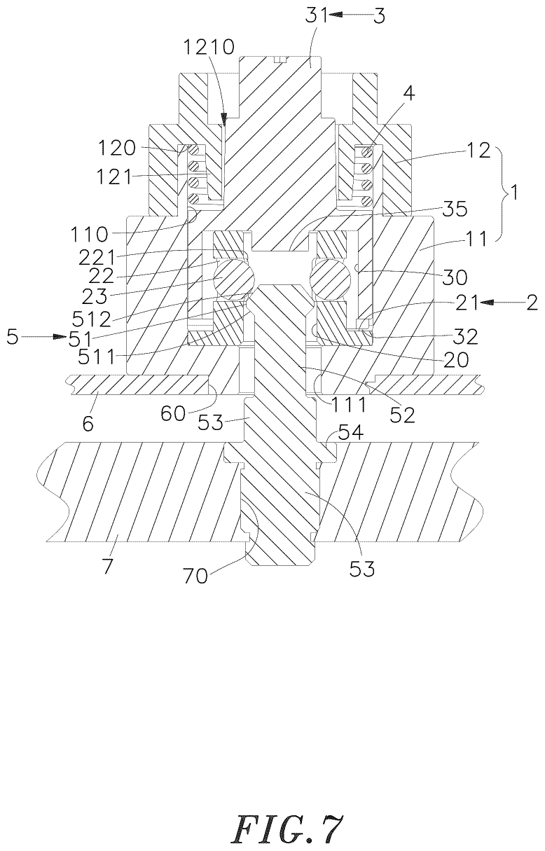

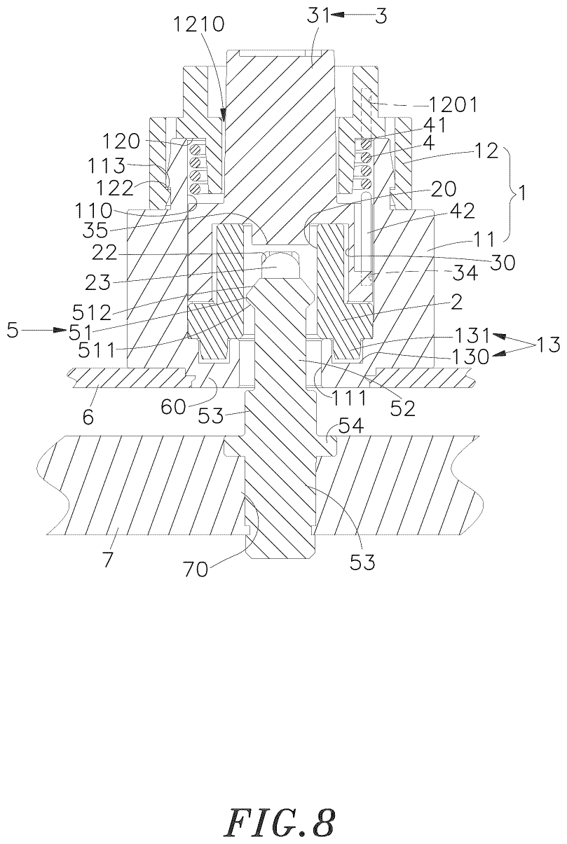

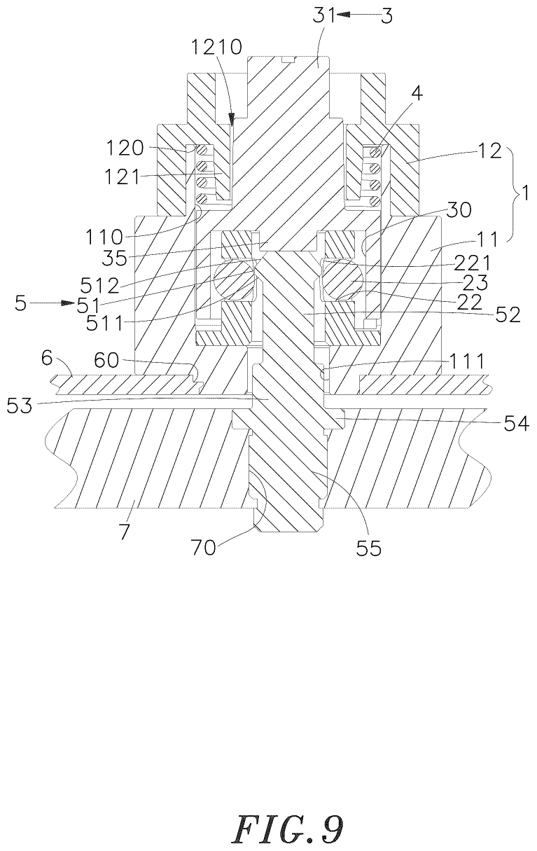

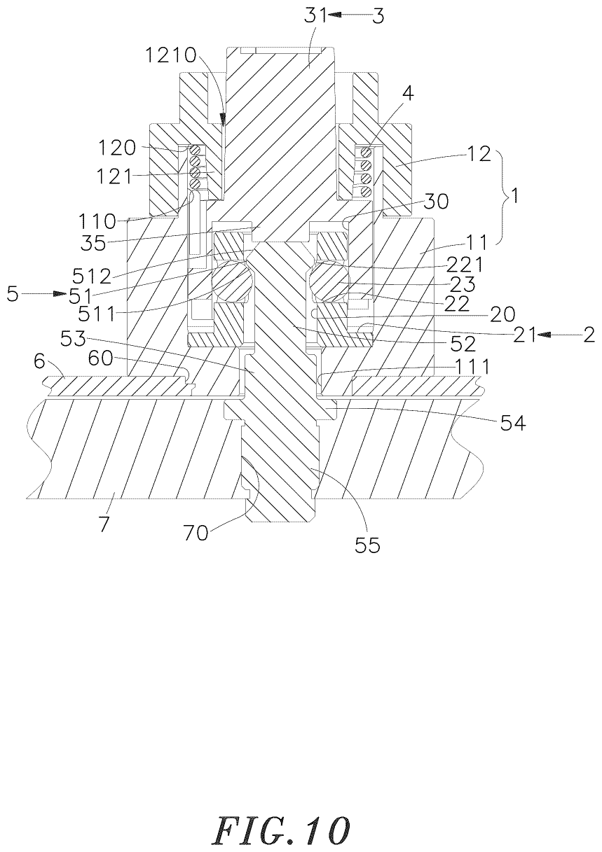

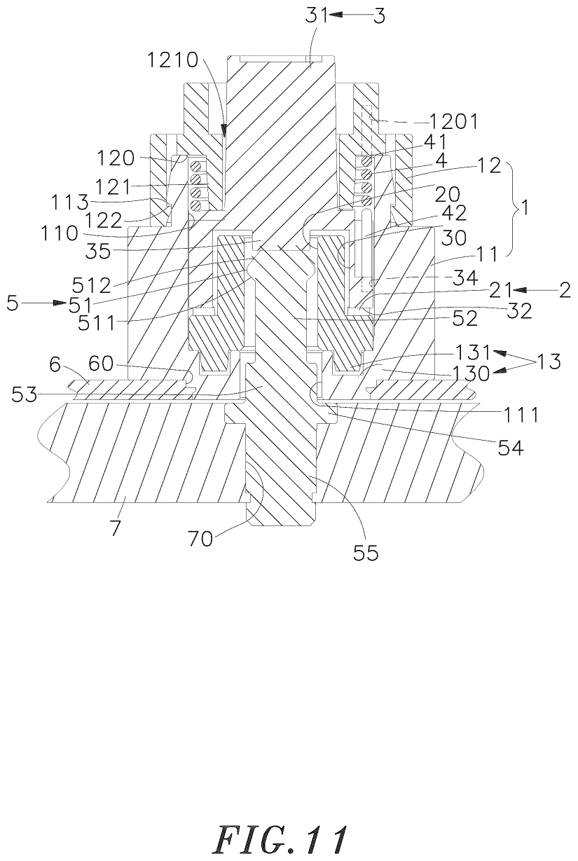

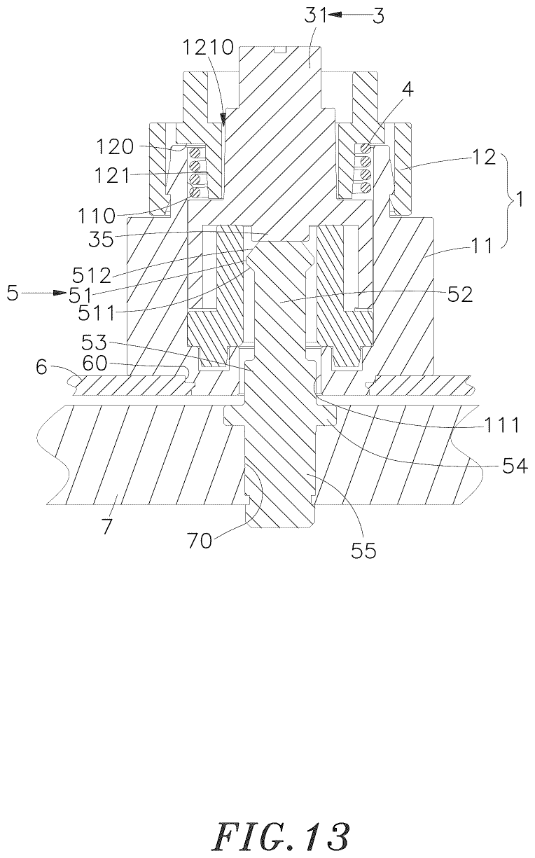

Please refer to FIGS. 1 to 14, the rotary positioning device and its application method of the present invention, the rotary positioning device comprises a housing 1, a limit member 2, a rotary block 3, an elastic member 4 and a docking shaft 5.

The housing 1 comprises a base 11 and a cover 12 disposed on the top of the base 11. The base 11 has a recessed interior with a receiving space 110, and a perforation 111 with a reduced aperture is provided at the bottom of the receiving space 110. The cover 12 is provided on the other side of the receiving space 110 opposite to the perforation 111. The cover 12 has an assembly space 120 disposed at the top of the base 11, a sleeve portion 121 protruded in the assembly space 120 and inserted into the receiving space 110, and a through hole 1210 provided inside the sleeve portion 121.

The limit member 2 is assembled at the receiving space 110 inside the base 11 and the cover 12. The limit member 2 comprises a through axial hole 20 inside, two opposite rotation guides 21 outside, two slots 22 radially penetrating to the outside and respectively provided on two sides of the axial hole 20, and a limiting ball 23 respectively provided inside each slot 22.

The rotary block 3 is assembled at the receiving space 110 inside the base 11 and the cover 12, and is mounted outside the limit member 2. The rotary block 3 comprises an accommodation chamber 30 inside, a reduced rod diameter steering shaft portion 31 outside which can be movably inserted into the through hole 1210 of the cover 12, two rotary slideways 32 respectively provided at two opposite sides of the bottom of the accommodation chamber 30 to slide and rise and fall along the rotation guides 21. Each rotary slideway 32 and each rotation guide 21 are respectively provided with positioning means 33 at a position adjacent to each other so as to be relatively movable and fastened for assembly and separation.

The elastic member 4 is sleeved between the outside of the sleeve portion 121 in the assembly space 120 of the cover 12 and the steering shaft portion 31 of the rotary block 3.

The docking shaft 5 is movably installed in the perforation 111 of the base 11 and then installed in the through axial hole 20 of the limit member 2. The docking shaft 5 comprises a stopper 51 located on the top thereof to push the limiting balls 23 on both sides of the through axial hole 20 to move in the slots 22.

The base 11 of the housing 1 of the present invention comprises a coupling portion 112 disposed outside the perforation 111 for coupling to a first docking hole 60 of a preset first panel 6, and at least one adjacent connecting portion 113 and at least one stopper surface 114 disposed outside the receiving space 110 relative to the perforation 111 and the coupling portion 112. The cover 12 of the housing 1 comprises at least one adjacent engaging portion 122 and at least one abutting surface 123 provided on the wall surface of the assembly space 120 for connecting and assembling with the at least one connecting portion 113 and the at least one stopper surface 114 respectively. The at least one connecting portion 113 of the base 11 disposed outside the receiving space 110 is in the shape of an inverted hook, and the at least one engaging portion 122 is in the shape of a hook, which can be connected and assembled with the connecting portion 113 by buckling.

A fixing structure 13 is provided at the bottom of the receiving space 110 and the bottom surface of the limit member 2. The fixing structure 13 comprises at least one fixing groove 130 provided at the bottom of the receiving space 110, and at least one protruding block 131 provided at the bottom surface of the limit member 2 for fixing with the at least one fixing groove 130. The at least one fixing groove 130 and the at least one protruding block 131 can be assembled and combined in a relative locking manner.

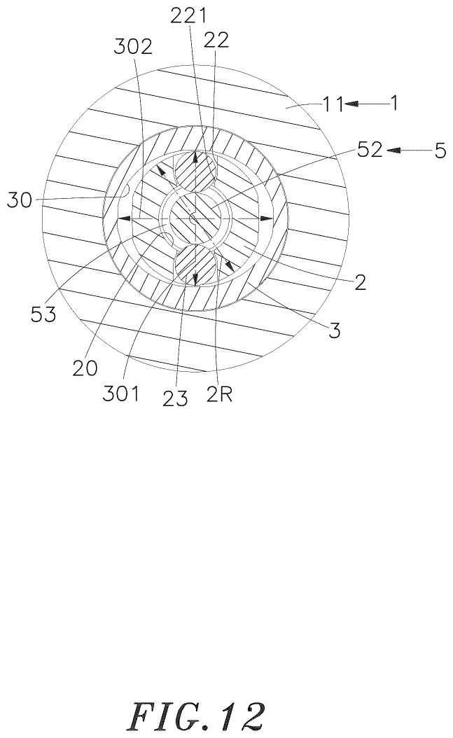

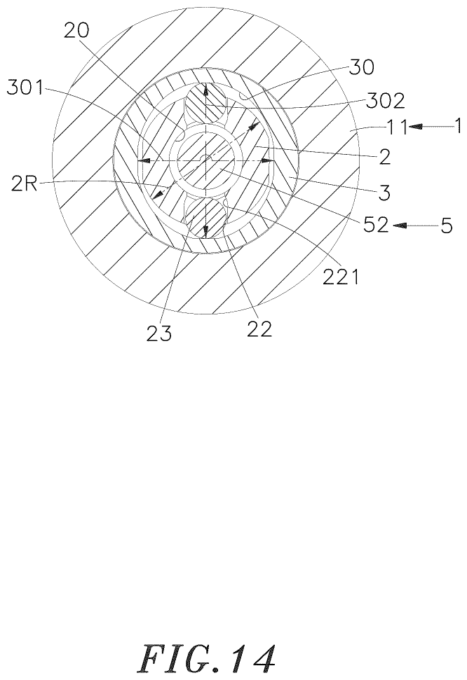

The accommodation chamber 30 disposed in the rotary block 3 of the present invention is an elliptical accommodation chamber, and the minor axis diameter 301 of the elliptical accommodation chamber 30 may be slightly larger than the rod diameter 2R of the limit member 2, and the major axis diameter 302 of the accommodation chamber 30 is larger than the rod diameter 2R of the limit member 2, so that the elliptical accommodation chamber 30 of the rotary block 3 can be located outside the limit member 2 and axially rotated. When the minor axis diameter 301 of the accommodation chamber 30 is aligned with the two limiting balls 23 of the limit member 2 (please also refer to FIG. 12), the two limiting balls 23 can be pushed into the two slots 22 respectively and clamped at the stopper 51 of the docking shaft 5. In addition, the inner sides of the two slots 22 are respectively provided with inner stop edges 221 which slightly protrude from the through axial hole 20 to prevent the two limiting balls 23 from escaping from the two slots 22 and from falling into the through axial hole 20. When the major axis diameter 302 of the accommodation chamber 30 is aligned with the two limiting balls 23 of the limit member 2, the two limiting balls 23 can be moved to partially expose outside the two slots 22 (please also refer to FIG. 14) and abut against the major axis diameter 302 of the accommodation chamber 30, and the stopper 51 of the docking shaft 5 can pass over the two limiting balls 23 and separate from the housing 1 and the limit member 2. In addition, a convex rod 35 is convexly provided on the top surface of the accommodation chamber 30 of the rotary block 3.

Furthermore, the cover 12 of the housing 1 of the present invention is provided with a first limiting hole 1201 on the outer top surface of the sleeve portion 121 inside the assembly space 120, through which a first latching rod 41 provided on one side of the elastic member 4 can be inserted and fixed. A second limiting hole 34 is provided on the outer side of the steering shaft portion 31 of the rotary block 3 for a second latching rod 42 provided on the other side of the elastic member 4 to pass through and fix, and for the rotary block 3 located in the assembly space 120 of the cover 12 to rotate and drive the elastic member 4 to rotate and form an elastic torque. The cover 12, the rotary block 3 and the twisted elastic member 4 is assembled and coupled to the receiving space 110 of the base 11, and the cover 12 is rotated to align the at least one engaging portion 122 and snap onto the at least one connecting portion 113 of the base 11 outside the receiving space 110 to form a limiting effect of upward and downward displacement in the radial direction, and the at least one stopper surface 114 is aligned with the at least one abutting surface 123 to form a limiting effect of axial rotation. Thus, the cover 12 is assembled and positioned on the base 11 to keep the elastic member 4 from being subjected to the torque generated by the rotation of the cover 12, so that the elastic member 4 is stably sleeved between the outer side of the sleeve portion 121 and the rotary block 3, and the elastic torque generated by the rotation of the elastic member 4 pulls the rotary block 3 to be assembled in the receiving space 110 of the base 1.

In addition, the positioning means 33 is provided at the bottom of the accommodation chamber 30 of the rotary block 3 of the present invention at positions adjacent to each rotary slideway 32 and each rotation guide 21 outside the limit member 2 for active assembly and separation. The positioning means 33 comprises relatively embedded and locked retaining protrusions 331 and locking grooves 330, or locking rods and locking round holes, etc. at two adjacent joint positions of each rotation guide 21 and each rotary slideway 32, which can be movably locked or separated, so that each rotation guide 21 and each rotary slideway 32 can be relatively rotated and slid, or locked and positioned.

The docking shaft 5 of the present invention further comprises a shaft 52 extending from one side of the stopper 51, a shaft seat 53 connected to one side of the shaft 52, a base body 54 connected to one side of the shaft seat 53, and a docking portion 55 connected to one side of the base body 54, that is, a shaft 52 with a reduced rod diameter is connected to one side of a stopper 51 of the docking shaft 5, and a shaft seat 53 with an enlarged rod diameter is connected to one side of the shaft 52, a base body 54 with an enlarged outer diameter is connected to one side of the shaft seat 53, and a docking portion 55 with a reduced rod diameter and a plurality of locking ribs 551 is connected to one side of the base body 54. The stopper 51 of the docking shaft 5 is provided with a first guide slope 511 extending obliquely to the shaft 52, and a second guide slope 512 is provided on the other side of the stopper 51 and is inclined outward in a gradually contracting manner relative to the first guide slope 511. The base body 54 and the docking portion 55 of the docking shaft 5 are provided for assembly at a second docking hole 70 of a preset second panel 7.

When performing locking or unlocking operation, the rotary positioning device of the present invention comprising the housing 1, the limit member 2, the rotary block 3, the elastic member 4 and the docking shaft 5 can be implemented according to the following steps:
(A01) Assemble the limit member 2, the rotary block 3 and the elastic member 4 sequentially in the receiving space 110 inside the base 11 of the housing 1, and rotate the steering shaft portion 31 of the rotary block 3 so that the two rotary slideways 32 at the bottom slide and move along rotation guides 21 on two sides of the limit member 2, and the locking grooves 330 of the positioning means 33 at adjacent positions of the two rotary slideways 32 and the two rotation guides 21 are respectively locked at the retaining protrusions 331, and at this time, the major axis diameter 302 of the elliptical accommodation chamber 30 of the rotary block 3 is located outside the limiting balls 23 on both sides of the limit member 2.
(A02) Place the elastic member 4 outside the steering shaft portion 31 of the rotary block 3 to insert the second latching rod 42 on one side of the elastic member 4 into the second limiting hole 34 and the first latching rod 41 on the other side of the elastic member 4 into the first limiting hole 1201 of the cover 12.
(A03) Assemble the cover 12 on the top of the base 11 to extend the sleeve portion 121 provided in the assembly space 120 inside the cover 12 into the receiving space 110 and expose the steering shaft portion 31 of the rotary block 3 outside the through hole 1210 of the sleeve portion 121, then rotate the cover 12 to align the at least one engaging portion 122 and snap onto the at least one connecting portion 113 of the base 11 outside the receiving space 110 to form a limiting function for radial upward and downward displacement, and to align the at least one stopper surface 114 with the at least one abutting surface 123 to form a limit function for axial rotation, so that the cover 12 is assembled and positioned on the base 11 to keep the elastic member 4 from being subjected to the torque generated by the rotation of the cover 12.
(A04) Assemble the coupling portion 112 at the bottom of the base 11 of the housing 1 to the first docking hole 60 of the preset first panel 6.
(A05) Assemble the docking portion 55 at the bottom of the docking shaft 5 to the second docking hole 70 of the preset second panel 7.
(A06) Then move the base 11 and the cover 12 of the housing 1, the limit member 2, the rotary block 3 and the elastic member 4 assembled in the internal receiving space 110 of the base 1 and the preset first panel 6 assembled at the bottom of the base 11 to above the stopper 51 of the docking shaft 5.
(A07) Aligned and place the perforation 111 of the base 11 of the housing 1 onto the stopper 51 of the docking shaft 5, and put the through axial hole 20 of the limit member 2 onto the stopper 51 so that the stopper 51 enters the inside of the through axial hole 20.
(A08) The second guide slope 512 of the stopper 51 pushes the two limiting balls 23 at the slots 22 on both sides of the through axial hole 20, so that the two limiting balls 23 are partially exposed outside the slots 22 and are pressed against the wall of the major axis diameter 302 of the accommodation chamber 30 of the rotary block 3, and the stopper 51 passes over the two limiting balls 23 and abuts against the convex rod 35 on the top surface of the accommodation chamber 30.
(A09) The stopper 51 supports the convex rod 35, and pushes the rotary block 3 located at the assembly space 120 and the steering shaft portion 31 located at the through hole 1210 to rise axially at the same time, thereby releasing the torsional force on the elastic member 4, so that the two rotary slideways 32 and the positioning means 33 at the two sides of the two rotation guides 21 of the limit member 2 can be separated and released.
(A10) The elastic reaction force of the elastic member 4 drives the rotary block 3 to rotate, and then the two rotary slideways 32 of the rotary block 3 and the two rotation guides 21 of the limit member 2 slide and displace axially relative to each other to drive the accommodation chamber 30 of the rotary block 3 to rotate, so that the minor axis diameter 301 is turned to the two limiting balls 23 located at the limit member 2 to push the two limiting balls 23 into the two side slots 22 respectively, and the two limiting balls 23 partially enter the through axial hole 20 to abut against the first guide slope 511 and the shaft 52 of the stopper 51.
(A11) Complete the assembly and positioning of the housing 1, the limit member 2, the rotary block 3, the elastic member 4, the docking shaft 5, the preset first panel 6 and the preset second panel 7.

If you want to separate and disconnect the preset first panel 6 and the preset second panel 7, you can do so by following the steps below:
(B01) Rotate the steering shaft portion 31 of the rotary block 3 again, so that the two rotary slideways 32 at the bottom slide and move along the rotation guides 21 on both sides of the limit member 2, and the elastic member 4 is rotated to twist at the same time.
(B02) The locking grooves 330 of the positioning means 33 at adjacent positions of the two rotary slideways 32 and the two rotation guides 21 are respectively clamped at the retaining protrusions 331 so that the major axis diameter 302 of the elliptical accommodation chamber 30 of the rotary block 3 is aligned with the outside of the limiting balls 23 on both sides of the limit member 2.
(B03) Pulled up the housing 1, the limit member 2, the rotary block 3, the elastic member 4 and he preset first panel 6 from the docking shaft 5 and the preset second panel 7, so that the two limiting balls 23 of the limit member 2 slide along the first guide slope 511 toward the two side slots 22, and the two limiting balls 23 partially expose outside the two slots 22 and abut against the wall surface of the major axis diameter 302 of the accommodation chamber 30.
(B04) The housing 1, the limit member 2, the rotary block 3, the elastic member 4 and the preset first panel 6 can be lifted and separated from the docking shaft 5 and the preset second panel 7 smoothly.
(B05) Complete the operation of unlocking and separating the preset first panel 6 and the preset second panel 7.

The above-mentioned rotary positioning device and its application method of the present invention, wherein the housing 1, the limit member 2, the rotary block 3, the elastic member 4 can be assembled at the preset first panel 6 (which can be a wing plate on both sides of an interface card, electronic card or expansion card used in an electronic device), and the docking shaft 5 can be assembled at the preset second panel 7 (which can be a panel of an electrical connector, providing plug-in and electrical connection for interface cards, electronic cards or expansion cards used in an electronic device). By vertically rotating, assembling or separating the housing 1, the limit member 2, the rotary block 3, the elastic member 4 and the docking shaft 5, the preset first panel 6 (which may be an interface card, an electronic card or an expansion card for electronic device applications) can be conveniently assembled or separated (plugged in or unplugged in) in a vertical manner on the preset second panel 7 (which may be an electrical connector for plugging and electrically connecting the interface card, an electronic card or an expansion card for electronic device applications). It has the advantages of easy operation, time-saving and labor-saving, and not easily affected by the surrounding environment and objects, and is extremely practical.

By means of the rotary positioning device and the application method of the present invention, the relative assembly, locking or separation, and unlocking operations between the housing 1, the limit member 2, the rotary block 3, the elastic member 4, the preset first panel 6, the docking shaft 5, and the preset second panel 7 are performed, so as to achieve the purpose of smoothly performing the relative assembly or separation between the two preset panels 6 and 7, and the operation of vertical automatic rotary docking locking or manual rotary unlocking is not easily hindered by surrounding space, objects, etc., so as to facilitate the assembly operation.

The above description is only a preferred embodiment of the present invention and does not limit the patent scope of the present invention. Therefore, all simple modifications and equivalent structural changes made by using the description and drawings of the present invention shall be included in the patent scope of the present invention and shall be clearly stated.

In summary, the above-mentioned rotary positioning device and its application method of the present invention can indeed achieve its effect and purpose when used. Therefore, this invention is truly an invention with excellent practicality and meets the application requirements for an invention patent, so the application must be filed in accordance with the law. We hope that the review committee will approve this case as soon as possible to protect the inventor's hard work. If the review committee has any doubts, please feel free to send us a letter for instructions. The inventor will do our best to cooperate. We sincerely appreciate it.

What is claimed is:

1. An application method of a rotary positioning device comprising a housing, a limit member, a rotary block, an elastic member and a docking shaft, said housing comprising a base and a cover, said base comprising a receiving space therein, said cover comprising an assembly space therein, said receiving space and said assembly space being equipped with corresponding said limit member and said rotary block, said elastic member being disposed at said assembly space of said cover and said rotary block, the application method comprising steps of:
(A01) assembling said limit member, said rotary block and said elastic member sequentially in said receiving space inside said base of said housing, and rotating a steering shaft portion of said rotary block so that two rotary slideways at a bottom slide of said rotary block move along respective rotation guides on two sides of said limit member, and said elastic member is simultaneously twisted, and at this time, an elliptical accommodation chamber inside said rotary block faces outside of two limiting balls located on both sides of said limit member;
(A02) placing said elastic member outside said steering shaft portion of said rotary block to insert a second latching rod provided on one side of said elastic member into a second limiting hole provided on said rotary block and a first latching rod provided on an opposite side of said elastic member into a first limiting hole provided on said cover;
(A03) assembling said cover on a top of said base to extend a sleeve portion provided in said assembly space inside said cover into said receiving space and expose said steering shaft portion of said rotary block outside said sleeve portion, then rotating said cover to align at least one engaging portion of said cover and snap onto at least one connecting portion of said base outside said receiving space to form a limiting function for radial upward and downward displacement, and to align at least one stopper surface of said base with at least one abutting surface of said cover to form a limit function for axial rotation, so that said cover is assembled and positioned on said base to keep said elastic member from being subjected to the torque generated by the rotation of said cover;
(A04) assembling a coupling portion at a bottom of said base of said housing to a preset first panel;
(A05) assembling a docking portion at a bottom of said docking shaft to a preset second panel;
(A06) moving said base and said cover of said housing, said limit member, said rotary block, said elastic member and said preset first panel together to above a stopper at a top of said docking shaft;
(A07) aligning and placing a perforation of said base of said housing onto said stopper of said docking shaft, and putting a through axial hole of said limit member onto said stopper so that said stopper enters an inside of said through axial hole;
(A08) a second guide slope of said stopper pushing said two limiting balls at respective slots on both sides of said through axial hole, so that said two limiting balls are partially exposed outside said slots and are pressed against a wall of a major axis diameter of said elliptical accommodation chamber of said rotary block, and said stopper passes over said two limiting balls and abuts against a top surface of said elliptical accommodation chamber;
(A09) said stopper pushing said rotary block located at said assembly space and said steering shaft portion located at a through hole of said cover to rise axially at the same time to release the torsional force on said elastic member, so that said two rotary slideways and positioning means at two sides of said two rotation guides of said limit member are separated and released.
(A10) the elastic reaction force of said elastic member driving said rotary block to rotate, and then said two rotary slideways of said rotary block and said two rotation guides of said limit member slide and displace axially relative to each other to drive said elliptical accommodation chamber of said rotary block to rotate, so that a minor axis diameter of said elliptical accommodation chamber of said rotary block is turned to said two limiting balls located at said limit member to push said two limiting balls into said two side slots respectively, and said two limiting balls partially enter said through axial hole to abut against a first guide slope and a shaft of said stopper; and
(A11) completing the assembly and positioning of said housing, said limit member, said rotary block, said elastic member, said docking shaft, said preset first panel and said preset second panel.

2. The application method as claimed in claim 1, wherein said housing in the steps (A01) and (A02) comprises a perforation provided at a bottom of said receiving space of said base, a coupling portion provided an outside of said perforation and coupled to a preset panel, and at least one connecting portion provided outside an opposite side of said receiving space relative to said perforation and said coupling portion; said cover of said housing comprises at least one engaging portion provided on a wall surface of said assembly space for connecting and assembling with said at least one connecting portion; a fixing structure is provided at a bottom of said receiving space and a bottom surface of said limit member, said fixing structure comprising at least one fixing groove provided at the bottom of said receiving space and at least one protruding block provided at the bottom surface of said limit member for fixing with said at least one fixing groove.

3. The application method as claimed in claim 2, wherein said base of said housing further comprises at least one stopper surface disposed outside said receiving space; said cover of said housing further comprises at least one abutting surface provided on the wall surface of said assembly space for connecting and assembling with said at least one stopper surface; said at least one connecting portion of said base disposed outside said receiving space is in the shape of an inverted hook, and said at least one engaging portion is in the shape of a hook to be connected and assembled with said at least one connecting portion by buckling.

4. The application method as claimed in claim 1, wherein said rotary block in the step (A03) is provided with said elliptical accommodation chamber inside, and a minor axis diameter of said elliptical accommodation chamber is larger than a rod diameter of said limit member, and a major axis diameter of said elliptical accommodation chamber is larger than said rod diameter of said limit member.

5. The application method as claimed in claim 4, wherein positioning means is provided at a bottom of said elliptical accommodation chamber of said rotary block at positions adjacent to each rotary slideway and each rotation guide outside said limit member for active assembly and separation, said positioning means comprising relatively embedded and locked retaining protrusions and locking grooves, or locking rods and locking round holes at two adjacent joint positions of each said rotation guide and each said rotary slideway.

6. The application method as claimed in claim 1, wherein said sleeve portion inside said assembly space of said cover in the step (A05) is provided with said first limiting hole on an outer top surface thereof for said first latching rod provided on one side of said elastic member to pass through and be fixed, and said steering shaft portion of said rotary block is provided with said second limiting hole on an outer side thereof for said second latching rod provided on the opposite side of said elastic member to pass through and be fixed, so that said elastic member is stably sleeved between the outer side of said sleeve portion and said rotary block.

7. The application method as claimed in claim 1, wherein said docking shaft in the steps (A05) to (A07) comprises said stopper, a shaft with a reduced rod diameter extending from one side of said stopper, a shaft seat with an enlarged rod diameter connected to one side of said shaft, a base body with an enlarged outer diameter connected to one side of said shaft seat and said docking portion with a reduced rod diameter connected to one side of said base body, said docking portion being provided with a plurality of locking ribs, said stopper comprising said first guide slope provided on one side thereof and extending obliquely to said shaft and said second guide slope provided on an opposite side thereof and inclined outward in a gradually contracting manner relative to said first guide slope, said base body and said docking portion of said docking shaft being provided for assembly at another preset panel.

8. A rotary positioning device, comprising a housing, a limit member, a rotary block, an elastic member and a docking shaft, wherein:
said housing comprises a base and a cover disposed on a top of said base, said base comprising a receiving space and a perforation with a reduced aperture provided at a bottom of said receiving space, said cover being set on said receiving space opposite to said perforation, said cover comprising an assembly space disposed at the top of said base, a sleeve portion protruded in said assembly space and inserted into said receiving space and a through hole provided inside said sleeve portion;
said limit member is assembled at said receiving space inside said base and said cover, said limit member comprising a through axial hole inside, two opposite rotation guides outside, two slots radially penetrating to the outside and respectively provided on two sides of said through axial hole and a limiting ball respectively provided inside each said slot;
said rotary block is assembled at said receiving space inside said base and said cover and mounted outside said limit member, said rotary block comprising an elliptical accommodation chamber defined on the inside thereof, a reduced rod diameter steering shaft portion located on the outside thereof and movably inserted into said through hole of said cover, two rotary slideways respectively provided at two opposite sides of the bottom of said receiving groove to slide and rise and fall along said rotation guides, and positioning means provided at adjacent positions between each said rotary slideway and each said rotation guide for assembly and separation.
said elastic member is sleeved between the outside of said sleeve portion in said assembly space of said cover and said rotary block;
said docking shaft is movably installed in said perforation of said base and then installed in said through axial hole of said limit member, said docking shaft comprising a stopper located on a top thereof for pushing said limiting balls on both sides of said through axial hole to move in said slots.

9. The rotary positioning device as claimed in claim 8, wherein said base of said housing further comprises a coupling portion disposed outside said perforation for coupling to a preset panel, and at least one connecting portion disposed outside said receiving space; said cover of said housing comprises at least one engaging portion provided on a wall surface of said assembly space for connecting and assembling with said at least one connecting portion.

10. The rotary positioning device as claimed in claim 9, wherein said base of said housing further comprises at least one stopper surface disposed outside said receiving space; said cover of said housing further comprises at least one abutting surface provided on the wall surface of said assembly space for connecting and assembling with said at least one stopper surface; said at least one connecting portion of said base disposed outside said receiving space is in the shape of an inverted hook, and said at least one engaging portion is in the shape of a hook to be connected and assembled with said at least one connecting portion by buckling.

11. The rotary positioning device as claimed in claim 8, wherein said housing further comprises a fixing structure provided at a bottom of said receiving space and a bottom surface of said limit member, said fixing structure comprising at least one fixing groove provided at the bottom of said receiving space and at least one protruding block provided at the bottom surface of said limit member for fixing with said at least one fixing groove.

12. The rotary positioning device as claimed in claim 8, wherein said elliptical accommodation chamber of said rotary block has a minor axis diameter thereof larger than a rod diameter of said limit member, and a major axis diameter thereof larger than said rod diameter of said limit member.

13. The rotary positioning device as claimed in claim 8, wherein said elastic member comprises a first latching rod provided on one side thereof, and a second latching rod provided on an opposite side thereof, said sleeve portion inside said assembly space of said cover is provided with a first limiting hole on an outer top surface thereof for said first latching rod provided on one side of said elastic member to pass through and be fixed, and said steering shaft portion of said rotary block is provided with a second limiting hole on an outer side thereof for said second latching rod provided on the opposite side of said elastic member to pass through and be fixed; said rotary block is located in said assembly space of said cover and rotated to drive said elastic member to twist to form elastic torque; said cover, said rotary block and the twisted said elastic member are assembled on said base so that said elastic member is sleeved between the outer side of said sleeve portion and said rotary block.

14. The rotary positioning device as claimed in claim 8, wherein said rotary block further comprises said positioning means provided at the bottom of said elliptical accommodation chamber at positions adjacent to each said rotary slideway and each said rotation guide for active assembly and separation, said positioning means comprising relatively embedded and locked retaining protrusions and locking grooves, or locking rods and locking round holes at two adjacent joint positions of each said rotation guide and each said rotary slideway.

15. The rotary positioning device as claimed in claim 8, wherein said docking shaft further comprises a shaft extending from one side of said stopper, a shaft seat connected to one side of said shaft, a base body connected to one side of said shaft seat and a docking portion connected to one side of said base body.

16. The rotary positioning device as claimed in claim 15, wherein said docking shaft further comprises said shaft with a reduced rod diameter extending from the one side of said stopper, said shaft seat with an enlarged rod diameter connected to the one side of said shaft, said base body with an enlarged outer diameter connected to the one side of said shaft seat and said docking portion with a reduced rod diameter connected to the one side of said base body, said docking portion being provided with a plurality of locking ribs.

17. The rotary positioning device as claimed in claim 15, wherein said stopper comprises a first guide slope provided on one side thereof and extending obliquely to said shaft and a second guide slope provided on an opposite side thereof and inclined outward in a gradually contracting manner relative to said first guide slope, said docking portion connected to said base body at one side of said shaft being provided for assembly at another preset panel.
